(19) United States
(12) Patent Application Publication
(10) Pub. No.: US 2004/0237251 A1
(43) Pub. Date: Dec. 2, 2004

(54) Wheel structure of handcart

(76) Inventor: Chul Young Kang, Pocheon-si (KR)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/852,102

(22) Filed: May 25, 2004

(30) Foreign Application Priority Data
May 26, 2003 (KR) 20-2003-0016304

(51) Int. Cl. B60B 33/00

(52) U.S. Cl. 16/45

(57) ABSTRACT

The present invention discloses an improved wheel structure of a handcart of the type having a body that is provided with a handle grip formed at one side thereof and a plurality of support plates disposed in such a manner as to be vertically stacked on one another, a wheel axially mounted to a support member in such a manner as to roll at four corners of the lower portion of the body, the support member having a bolt and a nut mounted on the top side thereof, and a tubular rod body connected at the lower side thereof to the bolt and connected at the upper side thereof to the body, the improvement wherein the tubular rod body has a nut receiving recess that is upwardly formed at the bottom surface thereof to receive the nut, such that a contact area between the rod body and the nut becomes large.

### BACKGROUND OF THE INVENTION

1. Field of the Invention

The present invention relates to a wheel structure of a handcart, and more particularly, to a wheel structure of a handcart wherein a rod body adapted to couple a handcart body with a wheel is structurally improved, such that the durability is markedly enhanced to ensure the long-term usage of the handcart and the reliability of a product is also improved.

2. Background of the Related Art

As well known, generally, a variety of handcarts are widely used in accordance with the places needing them.

For example, FIG. 1 shows a kind of handcart that is generally used in places like hospitals.

As shown in FIG. 1, the handcart used in hospitals includes a body 10, a handle grip 11 provided at one side of the body 10, a plurality of support plates 12 disposed in such a manner as to be vertically stacked on one another, and wheels 20 mounted at four corners of the lower portion of the body 10, respectively.

As shown in FIGS. 2a and 2b, the wheel 20 is axially mounted to a support member 21 in such a manner as to roll, and the support member 21 is protrudingly provided with a bolt 23 to which a nut 22 is fixed, at the top side thereof. The bolt 23 is inserted into a tubular rod body 30 that is adapted to couple the wheel 20 with the body 10.

In the conventional wheel structure of the handcart, however, there have occur the following problems.

First, the rod body 30 is generally flat over the entire bottom surface thereof except a hole of the tubular rod body into which the bolt 23 is inserted, and the nut 22 that is in close contact with the bottom surface of the rod body 30 just comes into contact with the flat bottom surface of the rod body 21. Thus, if the handcart is used for a long time period in the state where lots of burdens are placed on the support plates, load that is applied to the handcart body 10 is just transferred to the nut 22 via the bottom surface of the rod body 30, such that the bottom surface of the rod body 30 may be damaged or even broken by the pressure against the top side of the nut 22.

These problems mainly reside in that the pressure that is applied to the bottom surface of the rod body 30 is all collected to the top surface of the nut 22.

As a result, whenever the rod body 30 is damaged or broken, it should be replaced or repaired, thereby deteriorating reliability of products and shortening the lifespan of the products.

### SUMMARY OF THE INVENTION

Accordingly, the present invention has been made in view of the above-mentioned problems occurring in the prior art.

An object of the present invention is to provide a wheel structure of a handcart wherein a rod body adapted to couple a handcart body with a wheel is structurally improved such that the durability is remarkably enhanced to ensure the extended lifespan of the handcart.

Another object of the present invention is to provide a wheel structure of a handcart that is capable of improving its durability to thereby ensure reliability of products.

To accomplish the above objects, according to the present invention, there is provided an improved wheel structure of a handcart of the type having a body that is provided with a handle grip formed at one side thereof and a plurality of support plates disposed in such a manner as to be vertically stacked on one another, a wheel axially mounted to a support member in such a manner as to roll at four corners of the lower portion of the body, the support member having a bolt and a nut mounted on the top side thereof, and a tubular rod body connected at the lower side thereof to the bolt and connected at the upper side thereof to the body, the improvement wherein the tubular rod body has a nut receiving recess that is upwardly formed at the bottom surface thereof to receive the nut, such that a contact area between the rod body and the nut becomes large.

Preferably, the wheel structure of the handcart may further include an auxiliary nut engagedly fit to the front end of the bolt inserted into the tubular rod body.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a general handcart wherein the principles of the present invention can be embodied;

FIG. 2a is an exploded perspective view of the wheel structure of a conventional handcart;

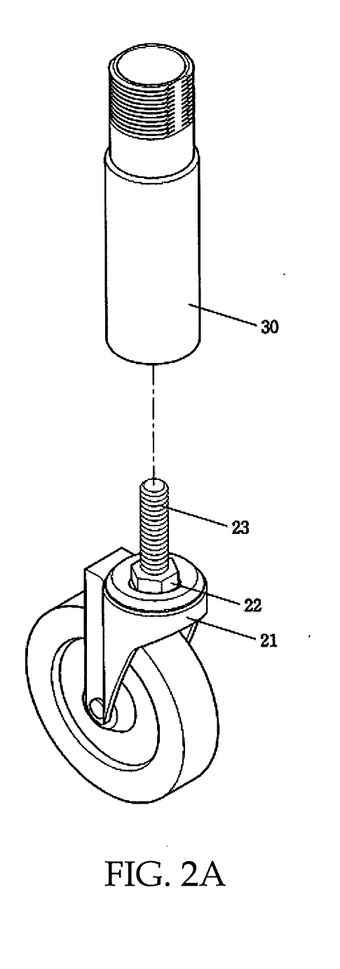

FIG. 2b is a sectional view of FIG. 2a;

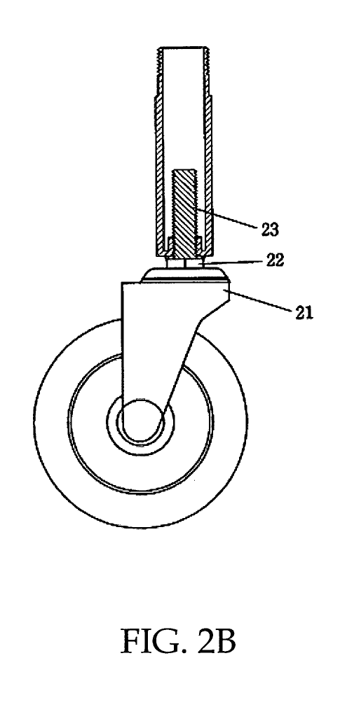

FIG. 3a is an exploded perspective view of the wheel structure of a handcart according to the present invention; and

FIG. 3b is a sectional view of FIG. 3a.

### DETAILED DESCRIPTION OF THE PREFERRED EMBODIMENT

Reference will now be made in detail to the preferred embodiments of the present invention, examples of which are illustrated in the accompanying drawings.

For the sake of convenience in description, the same parts as those in the conventional handcart will be denoted by the same numerals. In other word, an explanation on the same parts as those in the conventional handcart will be omitted.

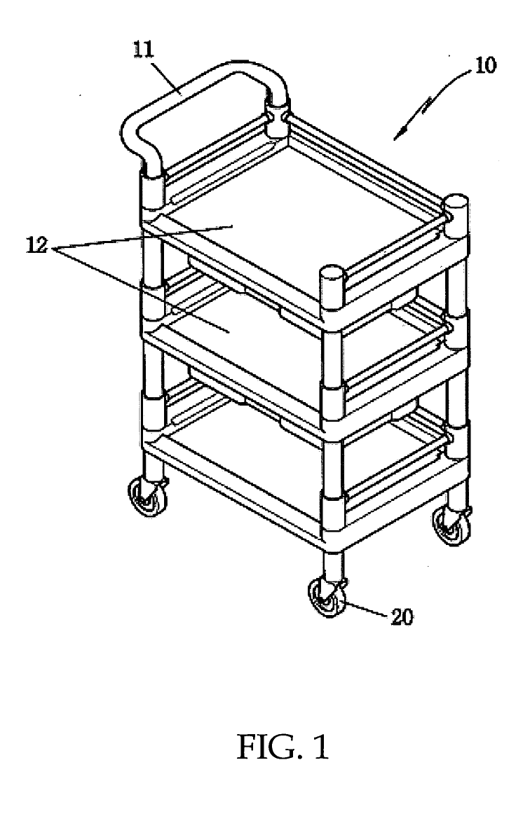

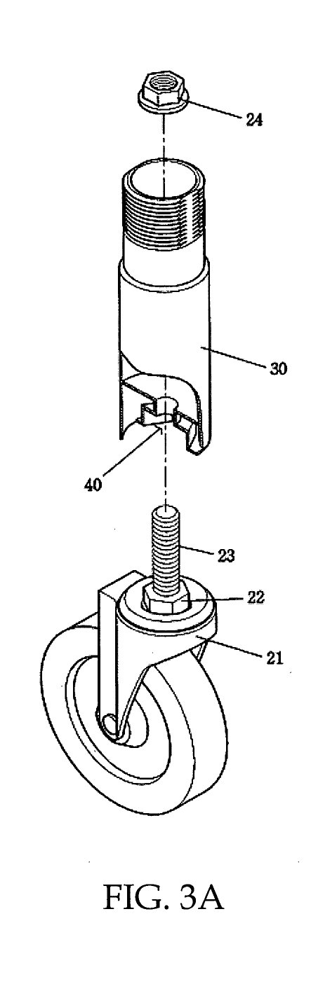

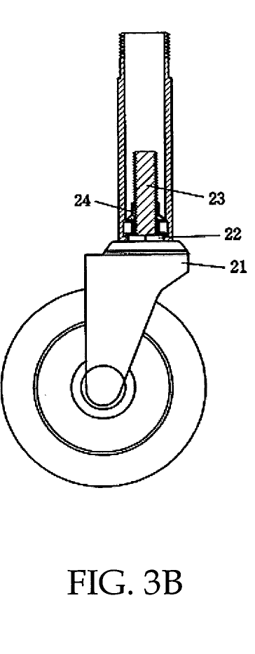

FIG. 1 is a perspective view showing an example of a handcart to which the principles of the present invention can be applied, and FIGS. 3a and 3b are exploded perspective and assembled views and showing the wheel structure of a handcart according to the present invention.

As shown in the drawings, the wheel of the present invention is mounted to the bottom portions of the body 10 that has a handle grip 11 formed at one side thereof and the plurality of support plates 12 disposed in such a manner as to be vertically stacked on one another.

The wheel 20 is axially mounted to the support member 21 in such a manner as to roll at four corners of the lower portion of the body 10, and the support member 21 has a bolt 23 and a nut 22 mounted on the top side thereof. The support member 21 of the wheel 20 is connected to the body 10 by means of a tubular rod body 30.

According to the feature of the present invention, the tubular rod body 30 has a nut receiving recess 40 that is upwardly formed at the bottom surface thereof to receive the nut 22, such that a contact area between the tubular rod body 30 and the nut 22 becomes large.

According to the present invention, preferably, the wheel structure of the handcart further includes an auxiliary nut 24 engagedly fit to the front end of the bolt 23 inserted into the tubular rod body.

As shown in FIG. 3b, the nut 22 that is placed on the top surface of the support member 21 is fully inserted into the nut receiving recess 40 that is formed on the bottom surface of the rod body 30, and in this state, the pressure of the body 10 that is applied to the nut 22 is dispersed as the contact area between the rod body 30 and the nut 22 becomes large.

As described above, according to the wheel structure of a handcart according to the present invention, the rod body for coupling the handcart body with the wheel is structurally improved such that the durability is remarkably enhanced to ensure the extended lifespan of the handcart.

In addition, the wheel structure of the present invention can improve its durability to thereby ensure reliability of products.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An improved wheel structure of a handcart of the type having a body that is provided with a handle grip formed at one side thereof and a plurality of support plates disposed in such a manner as to be vertically stacked on one another, a wheel axially mounted to a support member in such a manner as to roll at four corners of the lower portion of the body, the support member having a bolt and a nut mounted on the top side thereof, and a tubular rod body connected at the lower side thereof to the bolt and connected at the upper side thereof to the body, the improvement wherein the tubular rod body has a nut receiving recess that is upwardly formed at the bottom surface thereof to receive the nut, such that a contact area between the rod body and the nut becomes large.

2. The improvement wheel structure according to claim 1, further comprising an auxiliary nut engagedly fit to the front end of the bolt inserted into the tubular rod body.
